(19) United States
(12) Patent Application Publication
(10) Pub. No.: US 2009/0178517 A1
(43) Pub. Date: Jul. 16, 2009

(54) Nut driver system and method

(76) Inventor: Kurt Forrester, Copiaque, NY (US)

Correspondence Address: DOUGLAS C. WYATT;Wyatt, Gerber & O'Rourke, L.L.P., 99 Park Avenue, New York, NY, 10016, US

(21) Appl. No.: 12/008,749

(22) Filed: Jan. 14, 2008

(51) Int. Cl. B25B 13/48; B25B 23/16; B25B 13/06

(52) U.S. Cl. 81/124.2; 81/124.3

(57) ABSTRACT

An improve nut driver system and method of use, wherein the nut driver system includes a nut head socket, and an extended screw guide which is operatively connected to the nut head socket, wherein the nut head socket has an aperture at a side of the circumference of the nut head socket, and the extended screw guide has a slot at a side of the extended screw guide corresponding to the aperture of the nut head socket.

### BACKGROUND OF THE INVENTION

This invention is related to the art of nut driver systems, and more particularly related to the art of methods and systems for improved nut drivers for driving and removing nuts from long anchor screws.

A problem commonly faced by individuals desiring to fasten or unfasten nuts on long screws, is that because a long screw interferes with the use of conventional nut drivers, individuals can be limited to using wrenches and other devices to remove or fasten the nut. The use of wrenches and other devices can be undesirable, such as when a nut and screw are located in a difficult position, such as overhead, or where space around the nut is limited and therefore provides little room for use of a wrench.

### SUMMARY OF THE INVENTION

The present invention provides an improved nut driver system and method which overcomes the afore-mentioned problems. Accordingly, it is an object of the invention to provide an improved nut driver system which can be used to drive and remove nuts used on extended screws.

It is also an object of the invention to provide an improved nut driver for manipulating nuts, such as removing and tightening nuts, from screws in difficult to access locations.

It is a further object of the invention to provide an improved nut driver which can be used to manipulate nuts on long screws while using at least a portion of the long screw to guide the nut driver.

Another object of the invention is to provide an improved nut driver having a guide for guiding the nut driver in position over a nut for manipulation.

A further object of the invention is to provide an improved nut driver including means to apply additional torque for manipulating a nut.

It is a further object of the invention to provide an improved nut driver capable of manipulating nuts on long screws of various lengths. It is a further object of the invention to provide an improved nut driver capable of manipulating nuts of various sizes.

### BRIEF DESCRIPTION OF THE DRAWINGS

Preferred embodiments of the inventive devices are illustrated in the drawings and are described below.

FIG. 1 illustrates a side view of a nut driver system according to the present invention.

FIG. 2 illustrates several end views of a nut driver system according to the present invention, at the nut head socket end of the nut driver system.

FIG. 3 illustrates a side view of a nut driver system having a nut guide according to the present invention.

FIG. 4 illustrates a series of perspective views of a method of using a nut driver according to the present invention for manipulating a nut on a long screw.

FIG. 5 illustrates a side view of a nut driver system having an additional torque adding means according to the present invention.

FIG. 6 illustrates a side view of a nut driver system having an offset handle.

The above described figures may not be shown to scale, and are not intended to limit the scope of the description provided herein. Throughout the figures, the same reference numerals and characters, unless otherwise stated, are used to denote like features, elements, components or portions of the illustrated embodiments. Moreover, while the subject matter of the invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

A detailed description of a nut driver system and method is provided below for general applicability. In addition, several specific embodiments are provided as examples of the devices which one of ordinary skill in the art may apply these teachings to address specific problems and to illustrate the benefits and improvements of the system over known solutions.

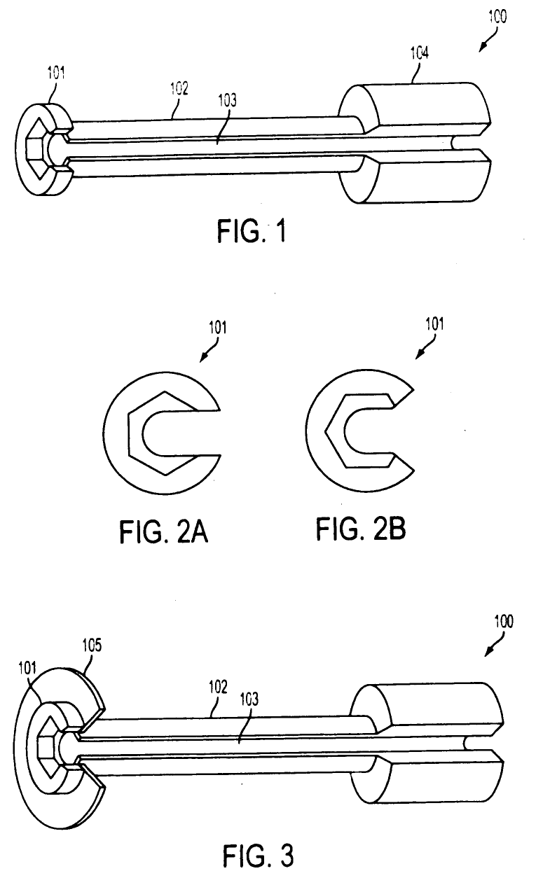

FIG. 1 shows a perspective side view of a nut driver system 100 according to the present invention. The nut driver system 100 includes a nut head socket 101 and an extended screw guide 102 connected to the nut head socket 101. A handle 104 can also be provided in various configurations.

FIGS. 2a and 2b shows an end view of a nut driver system 100 according to the present invention, at the nut head socket 101 end of the nut driver. The nut head socket can be provided in various configurations to accommodate different shapes of nuts, and nuts in different orientations. In addition, the nut head socket can be provided with widened opening to facilitate reception of a screw, as shown in FIG. 2b.

The nut head socket 101 according to the invention has a circumference and two sides. The circumference of the nut head socket 101 can be ring shaped. On one of the two sides an aperture is provided forming a portion of a cavity 103 for receiving a nut such as conventional nut drivers have. On a second of the two sides, which is opposite the first side, a slot is provided forming another portion of the cavity 103 through which a screw can pass. On the side of the slot, the nut head socket 101 can have a flat surface against which a portion of a nut can be received. In addition, the nut head socket 101 is provided with an interior surface forming part of the cavity against which leverage can be applied to manipulate a nut, such as to tighten or loosen a nut. For example, a nut head socket 101 can have an approximately hexagonally-shaped inner portion capable of manipulating a several sizes of hexagonal nut. The nut head socket 101 can be fabricated from hard materials that can resist wear from the torque forces and abrasion that can accompany use of the tool over time.

In addition, or in the alternative, the nut head socket 101 can manipulate nuts of various sized by utilizing known means of manipulating nuts of various sizes, such as by incorporating a wrench head.

A nut head socket 101 according to the invention includes an aperture through which at least a portion of a screw can pass. Accordingly, as shown in FIG. 1, a nut head socket 101 is preferably shaped for receiving a hexagonal nut, and has an aperture at at least one of the sides of the circumference of the nut head socket 101. It can be appreciated by individuals of ordinary skill in the art that variations of nut heads 101 can be provided without departing from the scope of the invention. As a non-limiting example, a nut head socket 101 can be shaped to receive a square nut, a notched ring nut, among other things.

An extended screw guide 102 is provided which is operatively connected to the nut head socket 101. The extended screw guide 102 provides a means for connecting the nut head socket 101 to a leverage means, and preferable includes a cavity within which at least a portion of a screw passing the slot of the nut head socket 101 can pass. The extended screw guide 102 is preferable tube-shaped and has an extended slot on one side which meets the slot of the nut head socket 101. The slot preferably has a width sufficient to permit passage of the diameter of a screw. The extended screw guide 102 is provided with at least one aperture at one of the two ends of the extended screw guide 102 through which a screw can pass into the cavity of the extended screw guide 102. The extended screw guide 102 can be fabricated from the same material as the nut head socket 101, or from lighter material sufficient so long at the extended screw guide can be operatively connected to the nut head socket 101 and can withstand the forces that accompany normal use of the device.

The extended screw guide 102 can be connected to a driver shaft for extending the reach of the nut head socket 101 and for connecting the extended screw guide 102 to a handle 104. It is preferable that the extended screw guide be of sufficient length to accommodate one or more of the objects of the invention mentioned above. In one embodiment of the invention the extended screw guide 102 can include an extension means for extending the length of the nut head driver system 100. It can be appreciated by a person or ordinary skill in the art that a number of extension means can be employed for extending the length of the nut head driver system 100. For example, the extension means can be a telescoping tube that is adjustable in several fixed positions. Alternatively, the extension means can be one or more modular shafts that can connect to one another at their ends to extend the length of the nut head driver system 100.

FIG. 3 shows a side view of an alternative embodiment of a nut driver system 100 according to the present invention further comprising a placement guide 105. The placement guide 105 provides a means for guiding the nut driver 100 into place over a nut and/or screw. The placement guide 105 is preferably disposed on a portion of the nut driver system 100 near the nut head socket 101. For example, the placement guide 105 can be disposed on the nut head socket 101, or on a portion of the screw guide proximate to the nut head socket 101. The placement guide 105 comprises at least two surfaces. Each of the two surfaces can be provided extending from each side of the slot of the extended screw guide 102, or at a portion of the aperture of the nut head socket 101. For example, in one embodiment, the placement guide can be ring shaped and can be provided with a slot coinciding with the slot of the extended screw guide 102 or the aperture of the nut head socket 101.

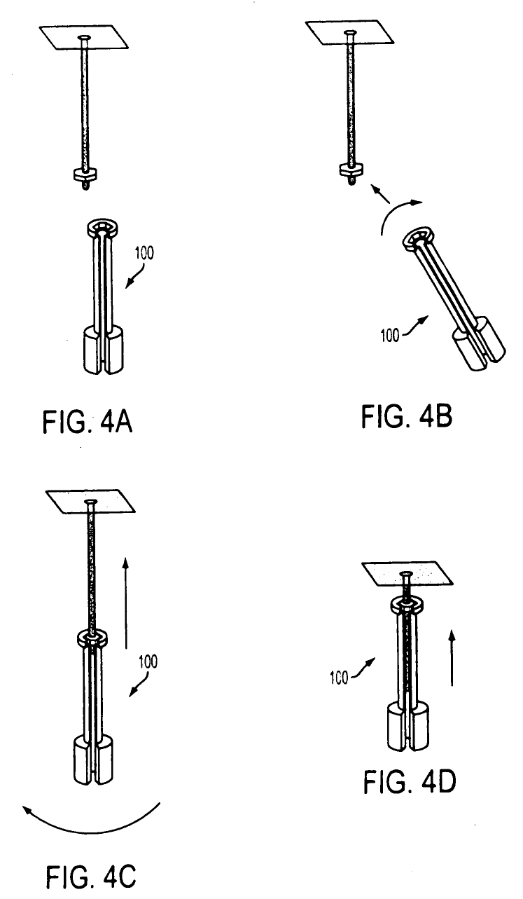

As shown in FIG. 4, a nut driver according to the present invention can be used for manipulating a nut on a long screw. One method of using an improved nut driver 100 according to the invention includes placing the nut driver over at least a portion of the screw and the nut. The nut driver 100 is guided into place over the nut, whereby the nut is guided within the nut head socket 101, and the screw is guided into place through the slot of the nut head socket 101, and the extended slot of the extended screw guide 102. For example, an end of the screw can be placed in either the aperture or cavity of the nut head socket 101, or in the aperture or cavity of the extended screw guide 102, and the nut and screw can thereafter be guided into place. Alternatively, the nut can be placed within the cavity of the nut head socket 101 and the screw can then be guided into place within the extended screw guide 102. The nut driver 100 can then be used to manipulate the nut, such as by tightening or loosening the nut, and rotating the nut on the screw.

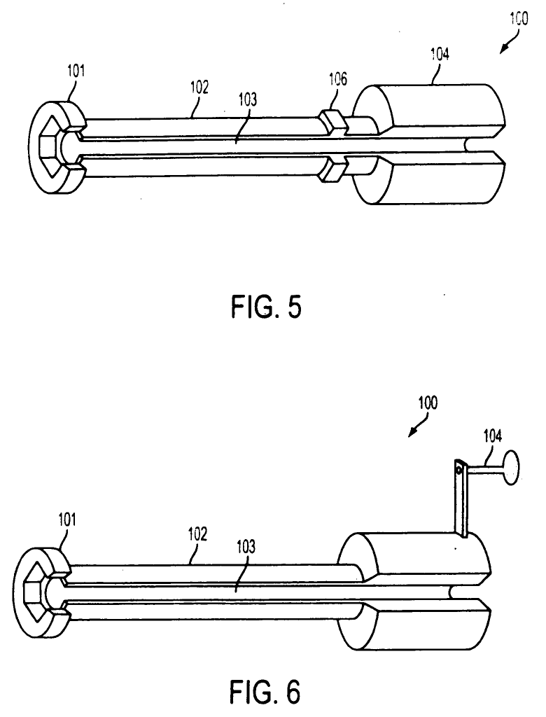

FIG. 5 shows a side view of an alternative embodiment of a nut driver system 100 according to the present invention further comprising a leverage means. The leverage means provides a means for applying torque to the nut driver system 100. In one embodiment, the leverage means can comprise a leverage base 106 disposed on a portion of the nut driver 100, such as at an end of the extended screw guide 102, or on a handle. A wrench or other device can be used in conjunction with the leverage base 106 for applying torque to the nut driver 100. It can be appreciated by a person of skill in the art that various configurations of an improved nut driver having a leverage means are possible. In one embodiment, the leverage base 106 can be disposed on the extended screw guide 102, and is preferable provided with an aperture aligned with the slot of the extended screw guide 102.

FIG. 6 shows a side view of an alternative embodiment of a nut driver system 100 according to the present invention wherein at least a portion of the handle is provided at an offset position from the extended screw guide 102, thereby permitting the extended screw guide 102 to accommodate long screws of various sizes without interference from the handle. The handle 104 can be provided with a rotatable joint at a connection of the handle 104 to the extended screw guide.

Although preferred embodiments of the nut driver system and method have been disclosed, a person of ordinary skill in the art can appreciate that other configurations of the nut driver system and method are possible and within the scope of the invention.

1. A nut driver system comprising:
a nut head socket, and
an extended screw guide operatively connected to the nut head socket, wherein the nut head socket has an aperture at a side of the circumference of the nut head socket, and the extended screw guide has a slot at a side of the extended screw guide corresponding to the aperture of the nut head socket.

2. A nut driver system according to claim 1 further comprising a placement guide disposed on the extended screw guide.

3. A nut driver system according to claim 1 further comprising a handle.

4. A nut driver system according to claim 3 wherein at least a portion of the handle is offset from the extended screw guide.

5. A nut driver system according to claim 3 further comprising a leverage base disposed on a portion of the extended screw guide.

6. A nut driver system according to claim 3 further comprising a leverage base disposed on a portion of the handle.

7. A nut driver system according to claim 1 further comprising a placement guide disposed on the nut head socket.

8. A nut driver system according to claim 3 further comprising at least one modular shaft between the extended screw guide and the handle for extending the length of the nut driver system.

9. A nut driver system according to claim 1 further comprising at least one telescoping tube that is adjustable in a plurality of positions.

10. A nut driver system according to claim 1 wherein the slot of the extended screw guide has a width greater than a width of the aperture and less than a width of a cavity of the nut head socket.

11. A nut driver system according to claim 1 wherein the extended screw guide is at least 6 inches in length to accommodate screws of various lengths.

12. A nut driver system according to claim 1 wherein the extended screw guide has an inner surface which is tubular in shape.

13. A nut driver system according to claim 1 wherein the extended screw guide has an inner surface which is tubular in shape.

14. A nut driver system according to claim 1 wherein the slot of the extended screw guide has a portion having a width greater than a width of the aperture and less than a width of a cavity of the nut head socket, said portion being disposed at an end of the extended screw guide proximate to the nut head socket.
